(19) United States
(12) Patent Application Publication
(10) Pub. No.: US 2005/0099025 A1
(43) Pub. Date: May 12, 2005

(54) Bumper for a bicycle trailer

(75) Inventor: Scott Sutherland, Hood River, OR (US)

Correspondence Address: WILMER CUTLER PICKERING HALE AND DORR LLP, THE WILLARD OFFICE BUILDING, 1455 PENNSYLVANIA AVE, NW, WASHINGTON, DC, 20004, US

(73) Assignee: 634182 Alberta Ltd., Calgary (CA)

(21) Appl. No.: 10/658,675

(22) Filed: Sep. 10, 2003

(30) Foreign Application Priority Data
Sep. 10, 2002 (DE) 102 42 197.8

(51) Int. Cl. B60R 19/42

(52) U.S. Cl. 293/127

(57) ABSTRACT

In order to protect in particular the exposed areas of the chassis of a bicycle trailer against wear and tear from friction and impacts, at least one bumper is provided, which is positioned on the outside of a frame part of the chassis and extends past the outside of the frame of the chassis in at least one direction.

### FIELD

The invention relates to a bicycle trailer with a chassis.

### BACKGROUND

Bicycle trailers are gaining increasing popularity as an alternative to bicycle child carriers that are mounted to the rear rack or the upper tube of the bicycle frame, because it provides far better protection for children.

The bicycle trailers must satisfy a variety of requirements. On one hand, they must have a sturdy and rigid passenger compartment so that the transported child is sufficiently protected in the event of an accident. It also must be ensured that the child can not be readily thrown from the seat in the event of an accident. Moreover, the bicycle trailer frame should be light in order to make pulling it as easy as possible. Finally, it should allow for space-saving storage.

With a well-known bicycle trailer made from lightweight material, the frame is comprised of a chassis on which the wheels are suspended and to which the drawbar is attached, and a passenger compartment that is supported by the chassis. The chassis essentially consists of two longitudinal bars that are connected in their mid-section by two crossbars. Frame elements of the passenger compartment are hinged between the bars in the front and the rear areas, and the passenger compartment can be folded in over the chassis.

The side walls and the rear wall of the bicycle trailer are made from textile and/or plastic sheets, the top and bottom edges of which are wrapped around the frame profiles of the passenger compartment and the chassis and fastened with hook and loop fasteners.

With such a light-weight bicycle trailer it is often perceived as a disadvantage that they seem unstable due to the comparatively thin frame profiles. Moreover, the side and rear walls that are attached to the frame profiles are exposed to particularly strong wear and tear from friction and bumps, in particular in the exposed areas of the chassis, and must therefore be reinforced. This applies especially to the side edges of the chassis, because the bicycle trailer is wider than the bicycle that pulls it and particularly the inexperienced cyclist is unable to correctly judge the width of the trailer, which naturally he cannot see while he is riding. This can also lead to problems when turning.

### SUMMARY

A bumper has been invented for a bicycle trailer. At least one bumper is located on the outside of a frame part of the chassis and projects from the outside of the frame part of the chassis at least in one direction.

Thus, at least one edge of the frame part and of the fabric possibly wrapped around it covered by the bumper is being protected against wear and tear. This results in the advantage that the wear and tear requirements that the fabrics used for the side and rear walls in the area of the chassis must satisfy are lower, which allows for considerable savings. Bumpers inevitably also lead to stabilization of the frame, provided the bumpers themselves are sufficiently stiff, and provide protection against impact damage to the frame. And last but not least, there is an optical advantage in that this protective function becomes clearly outwardly visible.

In one embodiment, the bumper has a greater overall height than the frame part, so that the bumper can extend past the frame part either at the top or at the bottom, or at top and bottom. Alternatively or additionally, the bumper can be built and arranged such that it projects past at least one edge or one end of the frame part. That way, a comprehensive protection of one or all frame parts of the chassis can be provided.

The bumper according to the invention fulfills a further protective function if it at least partially projects sideways past the chassis far enough to at least partially cover the front or rear space between the wheel and the chassis. This helps prevent objects from entering the space between the wheel and the chassis and from getting caught in the wheel hub, which in the worst case can lead to an accident.

In keeping with the lightweight construction, the bumper can be a hollow section, in particular a tube, the stiffness of which, compared to its mass, is relatively high. To seal the hollow section, at least one end of the bumpers can be capped with a plug.

In another embodiment the bumper takes on a weight-bearing function of the chassis. A bumper positioned in the front area of the chassis can for example carry the drawbar which can be connected to the bumper through a detachable connection. Moreover, a bumper positioned in the front area of the chassis can have a housing that enables the attachment of a front wheel so that the bicycle trailer can be converted into a baby jogger or a stroller.

It can also be advantageous if a hollow area in the bumper is developed as a storage space, for example to stow away tools, accessories for the bicycle trailer, a repair kit or similar items. Moreover, additional add-on parts, in particular reflectors and/or lights, can be positioned on the bumper.

The bumper upper surface can be formed to act as a step to facilitate ingress/egress to the trailer. As such, the bumper can be provided with a non-slip surface.

The bumpers are preferably used to protect the front and/or or rear corners of the bicycle trailer, which are most prone to suffer impacts.

If a bumper gets damaged, it is useful if it can be replaced without much effort. Therefore, the bumper is preferably built such that it can be attached to the frame part through a detachable connection, for example by being clamped or screwed to it.

Finally, it can be useful to position the bumper in the area of the height of the wheel hub, since this improves the tipping stability in the event of lateral impacts against the bumper.

### DRAWINGS

In the following, the invention is described in greater detail with the help of figures that show examples of preferred embodiments of the invention.

FIGS. 1 to 5 show horizontal cross-section of various chassis frames with bumpers thereon. To simplify things, the same reference numbers are used in all figures for identical or comparable elements or areas.

### DESCRIPTION

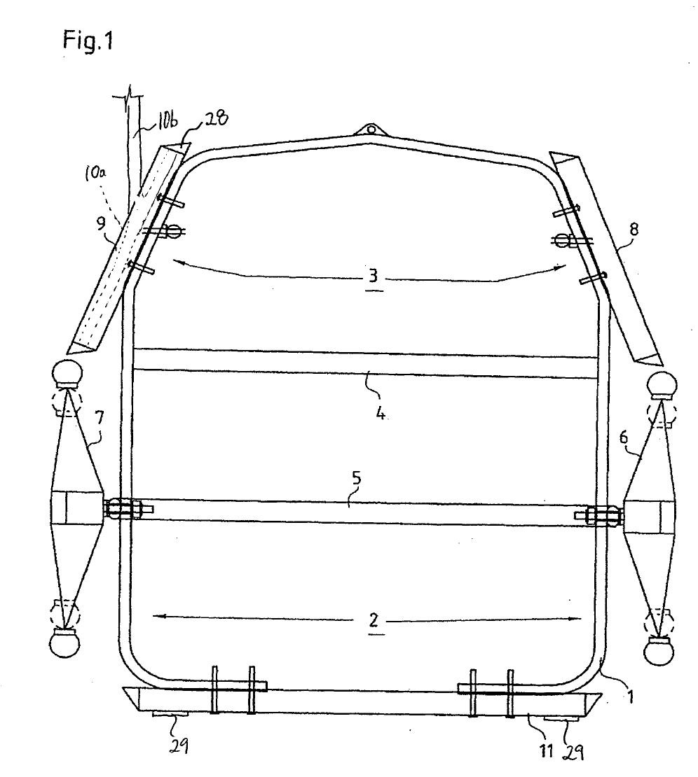

The chassis shown in profile in FIG. 1 has a frame formed from a frame section 1. In its rear area 2, the frame has a constant width, while at the front it has an area 3 that is slightly tapered toward the front end, with the frame section 1 forming an obtuse angle at the front side of the frame. The straight rear side of the frame is not continuous, the frame is open at the rear end. The frame is reinforced by two crossbars 4, 5, the rear cross bar 5 holding the wheels 6, 7.

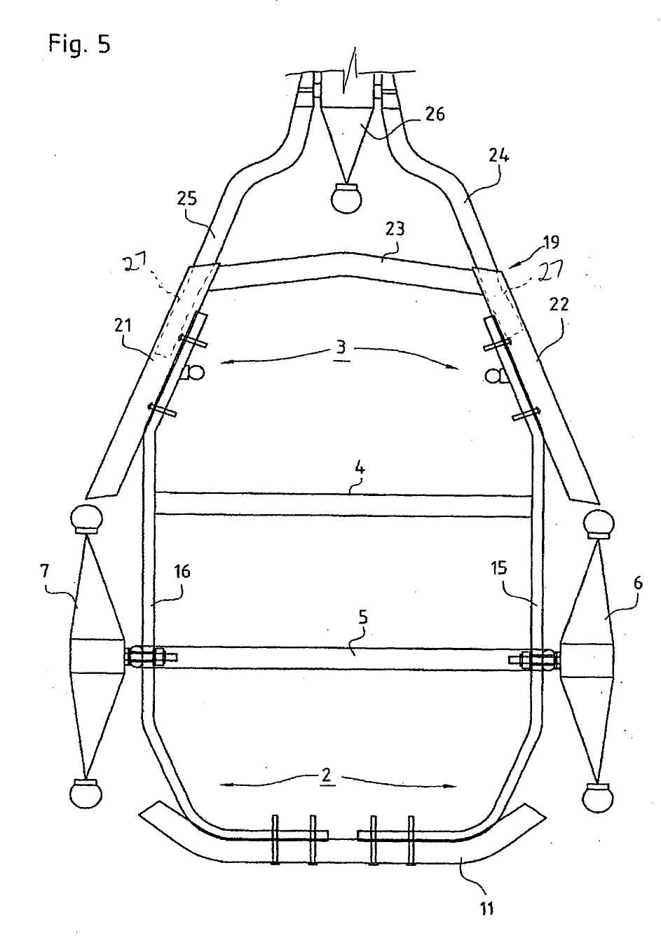

On both sides of the frame, bumpers 8, 9 are screwed onto the outer edge of the frame section 1 in the tapered area 3, with the tapered area of the frame being completely protected on the outside by the bumpers 8, 9. Moreover, towards the rear, the bumpers 8, 9 project far past the tapered area 3 almost all the way to the wheels, so that they cover the front spaces between the wheels 6, 7 and the chassis. At least one of the two bumpers 8, 9 is in the form of a hollow tube with a square hollow-area cross section 10a defined therein which defines a housing into which a detachable drawbar 10b can be inserted and fastened. Caps 28 are fixed on the ends of the bumpers. If both bumpers 8, 9 have such a housing (FIG. 5) they can also be used to accommodate fork arms between the free ends of which a front wheel is held, so that the bicycle trailer can be used as a so-called baby jogger, i.e. a stroller that can be used when jogging.

In one embodiment, hollow area cross section 10a can be used to form a storage compartment.

The backside of the frame, too, is completely covered on the outside by a bumper 11 that is screwed onto the frame section. In addition to the protective function, this bumper 11 also has a frame stabilizing function, as it connects the free ends of the frame section 1. Reflectors 29 or other add-on components can be fixed permanently or detachably to the bumpers.

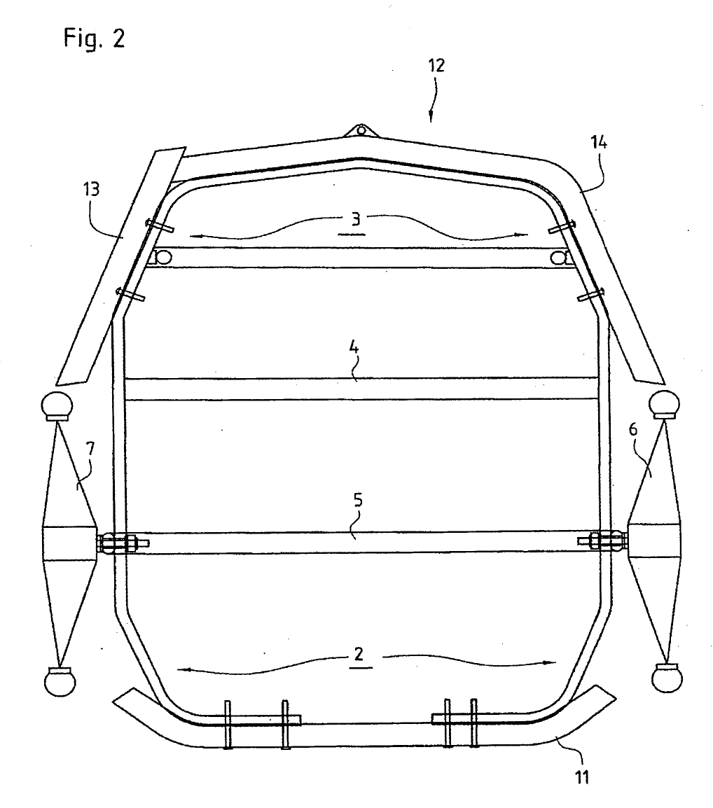

The chassis shown in FIG. 2 is different from that in FIG. 1 in that, on one hand, the rear area 2 of the frame also tapers towards the back and the ends of the rear bumper 11 are drawn slightly around the corners. On the other hand, contrary to the chassis described above, it has a two-part, wrap-around bumper 12, the first part 13 of which, projects past the tapered area 3 also towards the front. This first part 13 is joined on the side to the second part 14 of the bumper 12, which covers the entire front side of the frame as well as the other side of the tapered area 3, and, just like the first part 13, projects towards the back past the tapered area such that the spaces between the wheels 6, 7 and the chassis are covered. The first part 13 of the bumper 12 is again built in the form of a housing for a drawbar which can be inserted at the front and fastened inside the housing.

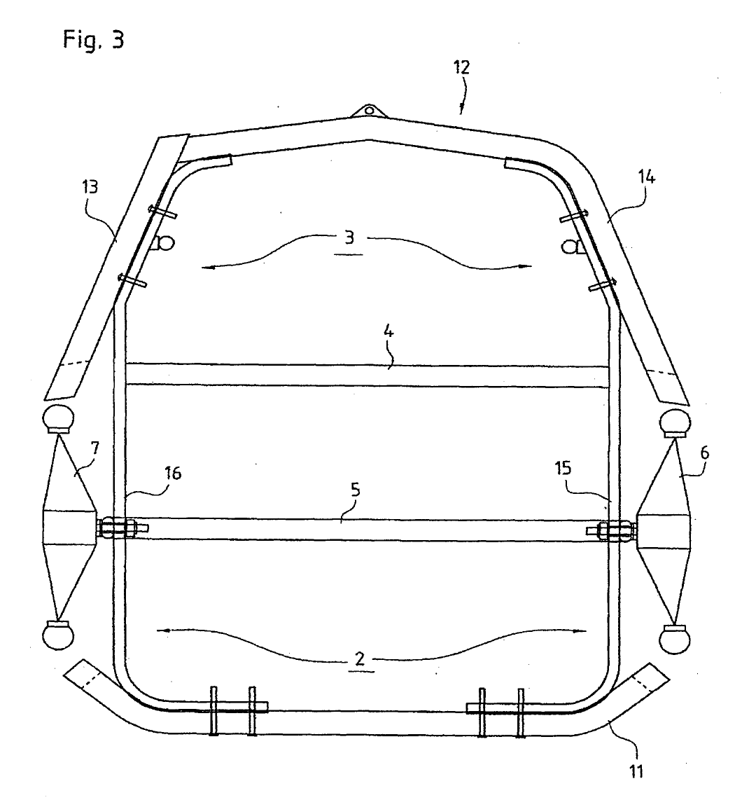

The chassis shown in FIG. 3 is different from the one shown in FIG. 2 mainly in that the frame does not have a continuous frame section, but is interrupted at its front as well as at its rear side. Thus, the wrap-around bumper 12 has the same frame stabilizing function here as the rear bumper 11; both bumpers 11, 12 connect the respective free ends of the sections forming the frame 15, 16. Moreover, the ends of the rear bumper 11 are angled towards the front and project past the corners of the frame far enough to cover the rear spaces between the wheels 6, 7 and the chassis.

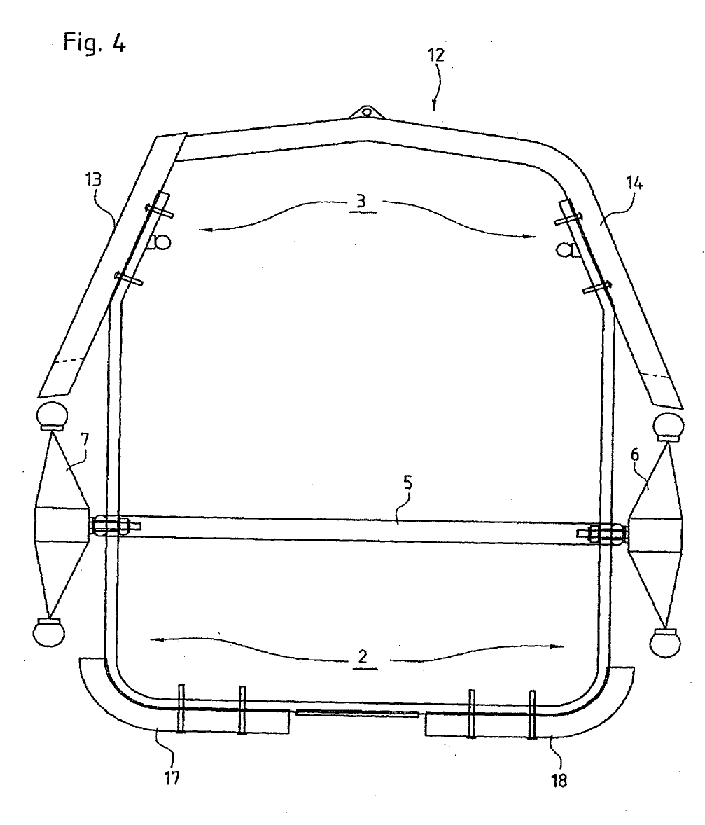

The chassis shown in FIG. 4 is different from the one shown in FIG. 2 in that the frame is continuous at the back and interrupted at the front. Moreover, instead of one bumper, two bumpers 17, 18 are provided at the back, which do not cover the frame in the middle area of the rear, but are drawn around both corners of the frame. Further the frame has only one crossbar 5, so that only the front bumper 12 takes on a frame stabilizing function.

FIG. 5 shows a chassis that is similar to that of FIG. 3, but has some differences compared the latter mainly in the front area 3. Thus, the two frame sections 15, 16 end already in the tapered area of the frame, so that the frame has no front edge at all. The front bumper 19 is comprised of three parts here, with two parts 21, 22 being attached to the inward angled sides of the sectional frame and projecting past these toward the front and the back. Both parts 21, 22 are connected to each other at their front ends via a transversal bumper element 23, so that the bumper 19 has a frame stabilizing function in this embodiment as well.

The bumper elements 21, 22 are both formed with a housing 27 for fork arms 24, 25, which are inserted from the front into the housings and between the free ends of which a front wheel 26 is held.

Many further modifications to the apparatus described and illustrated will readily occur to those skilled in the art to which the invention pertains. The specific embodiments described and illustrated herein should be considered only as illustrated and not be considered limiting of the scope of the claims.

1. A bicycle trailer with a chassis formed of at least one frame part, the bicycle trailer comprising: at least one bumper which is positioned on the outside of said at least one frame part of the chassis and which projects past the outside of said at least one frame part at least on a front end of the chassis.

2. The bicycle trailer according to claim 1, wherein said at least one bumper has a greater outer diameter dimension than said at least one frame part.

3. The bicycle trailer according to claim 1, wherein said at least one bumper projects past at least one of an edge and an end of said at least one frame part.

4. The bicycle trailer according to claim 1, wherein said at least one bumper extends sideways past the chassis far enough to at least partially cover one of a front space and a rear space between a wheel and the chassis.

5. The bicycle trailer according to claim 2, wherein said at least one bumper extends sideways past the chassis far enough to at least partially cover one of a front space and a rear space between a wheel and the chassis.

6. The bicycle trailer according to claim 3, wherein said at least one bumper extends sideways past the chassis far enough to at least partially cover one of a front space and a rear space between a wheel and the chassis.

7. The bicycle trailer according to claim 1, wherein said at least one bumper is hollow.

8. The bicycle trailer according to claim 7, wherein said at least one bumper is formed as a tube.

9. The bicycle trailer according to claim 8, wherein at least one of the ends of said at least one bumper is capped with a plug.

10. The bicycle trailer according to claim 1, wherein said at least one bumper takes on a weight-bearing function of the chassis.

11. The bicycle trailer according to claim 1, wherein said at least one bumper is positioned in a front area of the chassis and said at least one bumper is formed to hold a drawbar for the bicycle trailer.

12. The bicycle trailer according to claim 11, wherein the drawbar is detachably connected to said at least one bumper.

13. The bicycle trailer according to claim 1, further comprising at least one storage area in said at least one bumper.

14. The bicycle trailer according to claim 7, further comprising at least one storage area in said at least one bumper.

15. The bicycle trailer according to claim 1, further comprising a reflector located on said at least one bumper.

16. The bicycle trailer according to claim 1, wherein said at least one bumper comprises a plurality of bumpers positioned for protecting one of a front corner, a rear corner, and both a front and rear corner of said at least one frame part.

17. The bicycle trailer according to claim 1, wherein said at least one bumper is connected to said at least one frame part by a detachable connection.

18. The bicycle trailer according to claim 1, wherein said at least one bumper is positioned at about the height of a wheel hub of the bicycle trailer.

19. A bicycle trailer comprising:
a chassis having at least one frame part, and
at least one bumper positioned on the outside of said at least one frame part of the chassis, said at least one bumper projecting past the outside of said at least one frame part at least on a front end of the chassis.

20. The bicycle trailer of claim 1 wherein the at least one bumper extends from a front end of the chassis around to a side of the chassis ahead of a wheel on the chassis.

21. The bicycle trailer of claim 1 wherein the at least one bumper further projects past the outside of the frame on each side of the chassis ahead of any wheels on the chassis.

22. The bicycle trailer of claim 1 wherein the at least one bumper further extends from a rear end of the chassis.
